(19) United States
(12) Patent Application Publication
(10) Pub. No.: US 2012/0075408 A1
(43) Pub. Date: Mar. 29, 2012

(54) TECHNIQUE FOR PROVIDING IN-BUILT AUDIO/VIDEO BRIDGE ON ENDPOINTS CAPABLE OF VIDEO COMMUNICATION OVER IP

(76) Inventors: SATTAM DASGUPTA, Bangalore (IN); Anil Kumar Agara Venkatesha Rao, Bangalore (IN)

(21) Appl. No.: 12/983,334

(22) Filed: Jan. 3, 2011

(30) Foreign Application Priority Data
Sep. 29, 2010 (IN) 2887/CHE/2010

(51) Int. Cl. H04N 7/14

(52) U.S. Cl. 348/14.09; 348/E07.083

(57) ABSTRACT

A system and method for providing in-built audio/video bridge on endpoints capable of video communication over Internet protocol (IP) is disclosed. In one embodiment, a modified video communication terminal (MVCT), one or more of video communication terminals (VCTs) and one or more of voice over IP communication terminals (VoCTs) are connected via an IP network. Further, the MVCT includes an audio/video bridging module (AVBM). Furthermore, the audio/video bridging of incoming audio/video streams from the one or more of VCTs and VoCTs via the IP network is enabled by the AVBM for conferencing the participants.

Benefit is claimed under 35 U.S.C 119(a) to Indian Provisional Application Ser. No. 2887/CHE/2010 entitled “Technique for providing in-built n-way audio/video bridge on endpoints capable of IP video communication” by Ittiam Systems (P) Ltd filed on Sep. 29, 2010.

### FIELD OF TECHNOLOGY

Embodiments of the present invention relate to the field of audio/video bridge. More particularly, embodiments of the present invention relate to providing an audio/video bridge on endpoints that are capable of Internet protocol (IP) video communication.

### BACKGROUND

Video conferencing is a powerful tool for communication and collaboration and helps improve productivity and reduce costs for global companies. Further, video conferencing facilitates audio/video communication between geographically distributed teams in organizations.

With the rapid growth of packet-based Internet protocol (IP) infrastructure, IP-based video conferencing between multiple (typically 3 or more) participating locations is gaining prominence. Deployment of IP-based video conferencing provides numerous advantages, such as lower cost, easier access, rich media integration, network convergence, web-collaboration capabilities and the like.

Existing video conferencing systems include one or more IP video communication terminals (VCTs) and one or more voice over IP communication terminals (VoCTs) and a dedicated bridge or multipoint control unit (MCU) external to the VCTs and the VoCTs. The VCTs and the VoCTs are generally referred to as endpoints. Exemplary VCTs are any terminals capable of video communication over IP including desktop video phones, mobile or cell phones, video conferencing units and the like. Typically, participants at different locations use the VCTs to call into a common number or address that is assigned to the dedicated bridge in order to hear and view each other. Participants can also use the VoCTs to call into the dedicated bridge to participate in the conferencing, however they will only be able to hear each other's voice.

The existing dedicated bridge is a high performance, specialized, and typically centralized equipment that resides in an enterprise that is subscribed by a service provider located external to the endpoints. The dedicated bridge may receive audio/video streams from the participating VCTs and the VoCTs, process the received audio/video streams, combine them in one or more ways and send them back to the VCTs and the VoCTs.

Generally, the dedicated bridge receives audio/video streams from the participating endpoints. Further the dedicated bridge can encode and decode the video stream into a single video format or multiple video formats. Furthermore, the dedicated bridge mixes the incoming audio streams into as many audio streams as the number of endpoints. In addition, the composed audio/video streams are transmitted back to the endpoints.

In such a setup, the video conference calls between multiple VCTs and VoCTs are dependent on the availability of the external dedicated bridge. This may limit the ability to conference with multiple people as and when required. Also, the number of participating locations in the video conference call may depend on the audio/video processing capacity of the external dedicated bridge.

### BRIEF DESCRIPTION OF THE DRAWINGS

Embodiments of the present invention are illustrated by way of an example and not limited to the figures of the accompanying drawings, in which like references indicate similar elements and in which:

FIG. 1 is a block diagram of a video conferencing system, according to one embodiment;

FIG. 2 is similar to the video conferencing system, shown in FIG. 1, except it pictorially illustrates one aspect of a modified video communication terminal (MVCT) that allows participants to view each other, according to one embodiment;

FIG. 3 illustrates major functional sub-components of a audio/video bridging module (AVBM) that is capable of bridging endpoints, with asymmetric audio/video formats and resolutions, based on the processing capability of the MVCT, according to one embodiment;

FIG. 4 illustrates yet another audio/video bridging module (AVBM), such as those shown in FIG. 3, including additional major functional sub-components to enable virtual n-way audio/video bridging, according to one embodiment;

FIG. 5 is a process flow illustrating providing the in-built audio/video bridge on endpoints capable of IP video communication, according to one embodiment; and

FIG. 6 is another process flow illustrating providing virtual n-way audio/video bridging of endpoints, according to one embodiment.

Other features of the present embodiments will be apparent from the accompanying drawings and from the detailed description that follows.

### DETAILED DESCRIPTION

A system and method for providing in-built audio/video bridge on endpoints capable of video communication over Internet protocol (IP) is disclosed. In the following detailed description of the embodiments of the invention, reference is made to the accompanying drawings that form a part hereof, and in which are shown, by way of illustration, specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

The term “endpoints” refers to video communication terminals (VCTs) and voice over IP communication terminals (VoCTs). Exemplary VCTs include terminals capable of video communication over IP including desktop video phones, mobile or cell phones, video conferencing units and the like. The VoCTs include terminals capable of audio communication over IP. The term “bridge” refers to conferencing more than two endpoints capable of communication over IP.

The terms “signal” and “stream” are used interchangeably throughout the document. Also, the terms “endpoints” and “participants” are used interchangeably throughout the document.

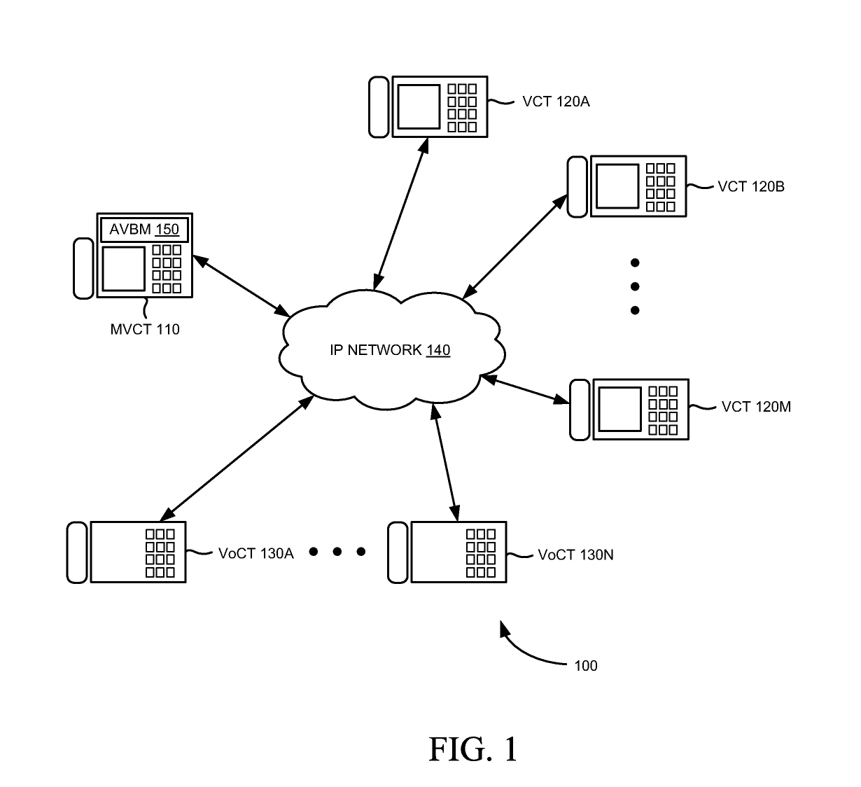

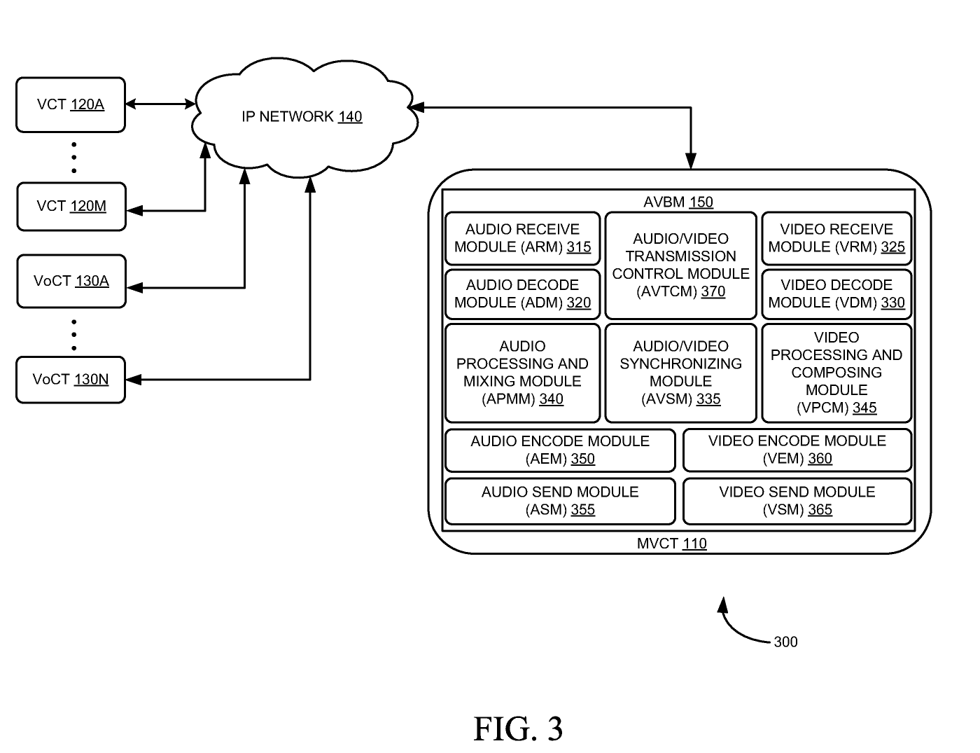

The present invention provides an in-built audio/video bridge on endpoints that are capable of video communication over IP. FIG. 1 is a block diagram of a video conferencing system 100, according to one embodiment. Particularly, the video conferencing system 100 includes a modified video communication terminal (MVCT) 110, one or more VCTs 120A-M and one or more VoCTs 130A-N connected via an IP network 140. Further, the MVCT 110 includes an in-built audio/video bridging module (AVBM) 150 which enables the audio/video bridging of incoming audio/video streams from the one or more VCTs 120A-M and the one or more VoCTs 130A-N, via the IP network 140, which is explained in more detail with reference to FIG. 3. Furthermore, the AVBM 150 can be implemented as software, hardware or a combination of software and hardware. Also, the AVBM 150 can be installed in any other VCTs 120A-M, in the video conferencing system 100, to act as a MVCT.

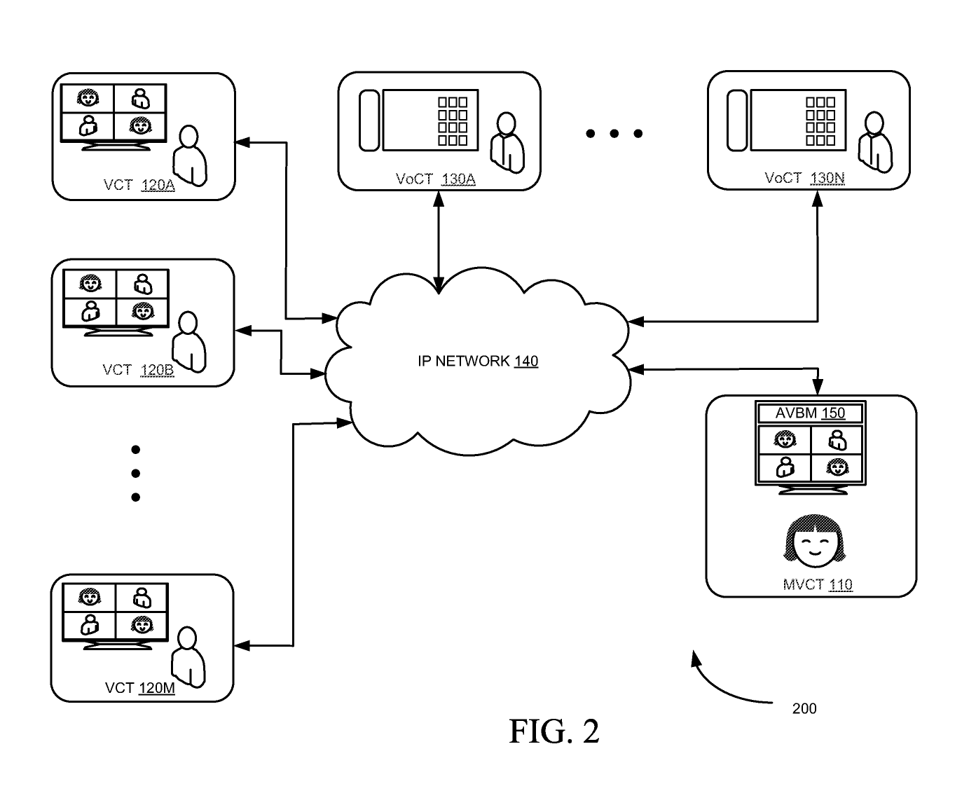

FIG. 2 is similar to the video conferencing system 100, shown in FIG. 1, except it pictorially illustrates one aspect of the MVCT 110 that allows multiple participants to view each other in a tiled composition of video, according to one embodiment. Particularly, FIG. 2 illustrates a participant, for example, at VCT 120A, viewing one or more of the other participants at the VCTs 120B-M and the participant at the MVCT 110 that are connected to the AVBM 150 at the MVCT 110 in the tiled composition of video. Further, it can be seen that the participant at the MVCT 110 can also view the participants at the VCTs 120A-M in the tiled composition of video, according to one embodiment.

In the example embodiment shown in FIG. 2, it can be seen that the image of a participant or list of participants is displayed to the participating one or more VCTs 120A-M by the MVCT 110 as explained in more detail with reference to FIG. 3. Further, it can be seen that the participants at the VoCTs 130A-N having only the audio communication capability can only listen to the voices of the other participants.

FIG. 3 illustrates major functional sub-components of the AVBM 150, shown in FIGS. 1 and 2, that is capable of bridging endpoints, with asymmetric audio/video streams based on the processing capability of the MVCT 110, according to one embodiment. The term “asymmetric audio/video streams” refers to audio/video streams coming from each endpoint being different from each other in format, frame rate, resolution, bit rate and the like. Particularly, FIG. 3 illustrates a block diagram 300 which includes the one or more VCTs 120A-M, the one or more VoCTs 130A-N and the MVCT 110 connected via the IP network 140. As shown in FIG. 3, the MVCT 110 includes the AVBM 150. The AVBM 150 enables the in-built audio/video bridging capability in the MVCT 110.

In this embodiment, the AVBM 150 includes an audio receive module (ARM) 315, an audio decode module (ADM) 320, an audio processing and mixing module (APMM) 340, an audio encode module (AEM) 350 and an audio send module (ASM) 355 to receive, decode, process, encode and send the audio streams. Further in this embodiment, the AVBM 150 includes a video receive module (VRM) 325, a video decode module (VDM) 330, a video processing and composing module (VPCM) 345, a video encode module (VEM) 360 and a video send module (VSM) 365 to receive, decode, process, encode and send the video streams. Furthermore in this embodiment, the AVBM 150 includes an audio/video synchronizing module (AVSM) 335 to synchronize the audio and the video streams. Also, the AVBM 150 includes an audio/video transmission control module (AVTCM) 370 to control parameters of the audio/video streams, such as the resolution, bit rate, frame rate, and the like from each of the participants connected to the MVCT 110. This enables bridging of more than otherwise possible participants by reducing the processing power needed by the MVCT 110 to bridge the participants or by reducing the effective bit rate required at the MVCT 110.

In one embodiment, the ARM 315 enables the MVCT 110 to receive multiple audio streams in different formats, from the one or more VCTs 120A-M and the one or more VoCTs 130A-N, and, if required, de-jitters each audio stream independently. Further, the ADM 320 enables decoding fully or partially each of the de-jittered audio stream. The VRM 325 enables the MVCT 110 to receive multiple video streams in different formats and resolutions, from the one or more VCTs 120A-M, and, if required, de-jitters each video stream independently. Further, VDM 330 enables decoding fully or partially each of the de-jittered video stream.

Further in this embodiment, the AVSM 335 synchronizes each of the decoded audio/video streams of the participants connected to the MVCT 110 before local play out. Furthermore, the AVSM 335 synchronizes the audio/video streams before encoding and streaming out for each of the one or more VCTs 120A-M and the one or more VoCTs 130A-N connected to the MVCT 110. Also, the AVSM 335 works across all the other sub-components of the AVBM 150 to track and re-timestamp the audio/video streams as required, in order to achieve the audio/video synchronization of the transmitted streams.

Furthermore in this embodiment, the APMM 340 enables post processing of the audio stream coming from each connected VCTs 120A-M and/or VoCTs 130A-N before playback and/or re-encoding. Exemplary post-processing includes mixing the incoming audio streams based on a weighted averaging for adjusting the loudness of the audio stream coming from each connected one or more VCTs 120A-M or one or more VoCTs 130A-N. Moreover, the APMM 340 produces separate audio stream specific to each connected one or more VCTs 120A-M and one or more VoCTs 130A-N by removing an audio stream originating from that VCT or VoCT and mixing the audio streams coming from one or more other connected one or more VCTs 120A-M and/or the one or more VoCTs 130A-N.

In addition in this embodiment, the VPCM 345 enables processing the decoded video streams received from the VDM 330. The processing of the decoded video streams includes processes, such as resizing the video streams and composing the video streams. Exemplary composing of the video streams includes tiling the video streams. Furthermore in this embodiment, the AEM 350 enables encoding each of the audio streams coming from the APMM 340, separately, in a format required by each of the associated and connected one or more of VCTs 120A-M and the one or more of VoCTs 130A-N. In addition in this embodiment, the ASM 355 enables receiving each of the audio streams from the AEM 350 and sending the encoded audio streams to each of the associated one or more of VCTs 120A-M and the one or more of VoCTs 130A-N.

Moreover in this embodiment, the VEM 360 enables encoding each of the composed video streams coming from the VPCM 345 in a format and resolution supported by each of the associated and connected one or more VCTs 120A-M. Further in this embodiment, the VSM 365 enables receiving each of the encoded video streams from the VEM 360 and sending them to associated one or more VCTs 120A-M.

In this embodiment, the AVTCM 370 can control parameters such as, resolution, bit rate and frame rate of the audio/video streams coming from each of the endpoints connected to the MVCT 110. Further, the AVTCM 370 can request an endpoint to reduce the bit rate and/or resolution of transmission of the audio/video streams to reduce the bandwidth requirement and the processing power required at the MVCT 110 and thereby increases the number of participating endpoints at the MVCT 110 without compromising on the bridging experience. An exemplary case of requesting, receiving and decoding 4 low resolution images of Quarter Video Graphics Array (commonly known as QVGA) streams to compose one higher resolution Video Graphics Array (commonly known as VGA) stream at the MVCT 110 for display as well as re-encoding, as against decoding 4 VGA streams, resizing each to QVGA before composing the images to a VGA resolution to display/re-encoding to achieve the same effect, but with significant reduction of processing requirement at the MVCT 110.

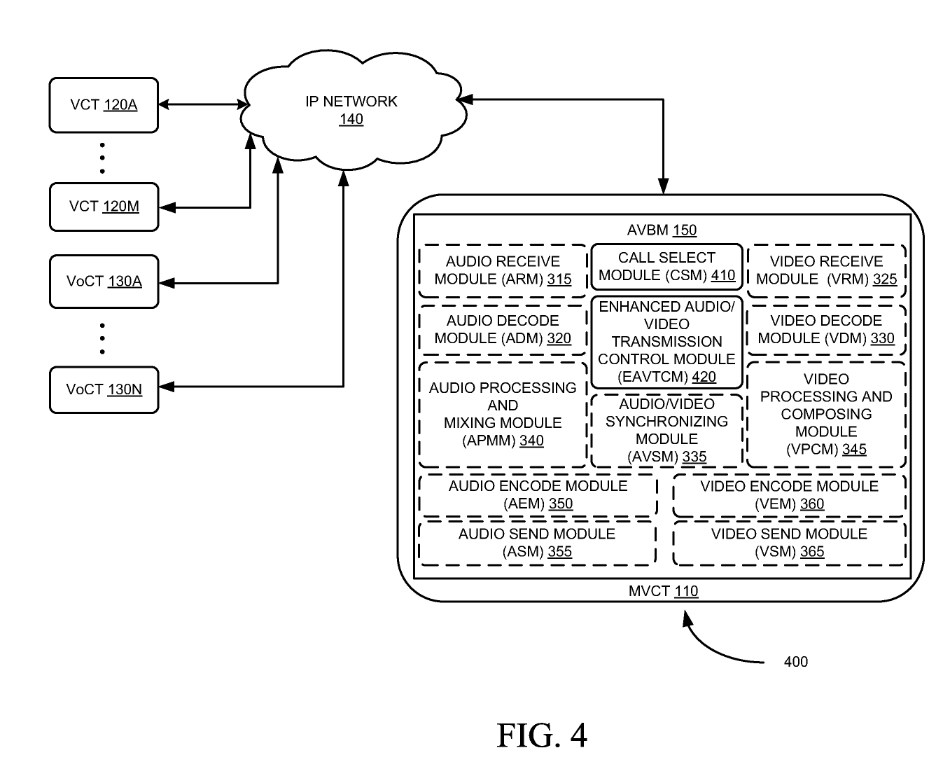

In this embodiment, the number of participating endpoints at the MVCT 110 is limited to the audio/video processing capability of the MVCT 110. Further, in this embodiment, the MVCT 110 supports asymmetric audio/video streams received from the one or more of VCTs 120A-M and the one or more of VoCTs 130A-N. In one embodiment, the number of participating endpoints at the MVCT 110 that can be supported by the MVCT 110 can be increased beyond the audio/video processing capacity of the MVCT 110 to enable virtual n-way audio/video bridging in the MVCT 110. This is explained in more detail with reference to FIG. 4.

FIG. 4 illustrates yet another AVBM 150, such as those shown in FIG. 3, including an additional major functional sub-component to enable virtual n-way audio/video bridging, according to one embodiment. Particularly, FIG. 4 illustrates the AVBM 150 including the additional a call select module (CSM) 410. In one embodiment, the ARM 315, the ADM 320, the VRM 325, the VDM 330, the AVSM 335, the APMM 340, the VPCM 345, the AEM 350, the ASM 355, the VEM 360 and the VSM 365 (shown in FIG. 3) along with the CSM 410 and the EAVTCM 420 enables a virtual n-way audio/video bridging in the MVCT 110.

In this embodiment, the CSM 410 enables automatic and/or manual selection of a participant or a list of participants based on preselected criteria to enable virtual n-way audio/video bridging capability in the MVCT 110. This automatic and/or manual selection of the participant or the list of participants facilitates in reducing the processor intensive audio/video processing during audio/video bridging to the processing capability of the MVCT 110 without limiting the number of participants calling into the MVCT 110.

In this embodiment, the automatic selection of the participant or the list of participants by the CSM 410 takes control inputs from the MVCT 110 based on selection parameters and selection criteria. Further in this embodiment, the CSM 410 monitors all the participating endpoints at the MVCT 110 and based on the selection parameters and the selection criteria, the CSM 410 selects one or more active participants.

Exemplary selection parameters or the selection criteria include specific participants to be decoded and displayed, the number of participants who are active (i.e., for example, the participant at the endpoint is speaking), participants who were active just before the currently active participant and so on. The CSM 410 can also select a participant as an active participant, if that participant has remained active for a predefined duration of time. Further, the audio/video streams from the selected active participants are decoded and displayed to the other endpoints at the MVCT 110.

In another embodiment, the manual selection of the participant or the list of participants by the CSM 410 includes selection through signaling via standard protocols, such as dual tone multiple frequency (DTMF) from the participants who want to be selected as an active participant or through manual selection at the MVCT 110. Further, the number of active participants that can be chosen using the manual selection is significantly higher than the number of active participants that can be chosen using the automatic selection. In an extreme use case scenario, only the audio/video from one of the participating endpoints can be selected at a time. Therefore, the number of participating endpoints is independent of the processing capability of the MVCT 110.

Further in this embodiment, the processing of the audio/video streams by the MVCT 110 is reduced by the CSM 410 by limiting the number of audio signals that are to be encoded and streamed to all or a subset of the participating endpoints based on a certain predefined criteria. Furthermore, the CSM 410 limits the number of audio signals from the participating endpoints to be mixed, encoded and sent to all other participants based on the trend of number of simultaneous speakers in the conference call.

In this embodiment, the EAVTCM 420 allows reduction/management of bandwidth needed for conferencing the participants connected via the one or more VCTs 120A-M and/or the one or more VoCTs 130A-N. In an example embodiment, an inactive participant is requested to switch off or scale down the video resolution and/or bit rate, thereby decreasing the overall bandwidth requirements. Further, this allows any other active participant to transmit video at a higher resolution and/or bit rate. In addition, the EAVTCM 420 can request an active participant to reduce the bit rate and/or resolution of transmission of the audio/video streams to reduce the bandwidth requirement and the processing power required at the MVCT 110 and thereby increases the number of active participants at the MVCT 110. Furthermore, the EAVTCM 420 allows the inactive participants to request or re-negotiate for video re-transmission when they are active. The EAVTCM 420 also enables synchronization frame request for faster video synchronization response. One skilled in the art can envision having the AVBM 150 and/or one or more of the associated blocks inside and/or outside the MVCT 110.

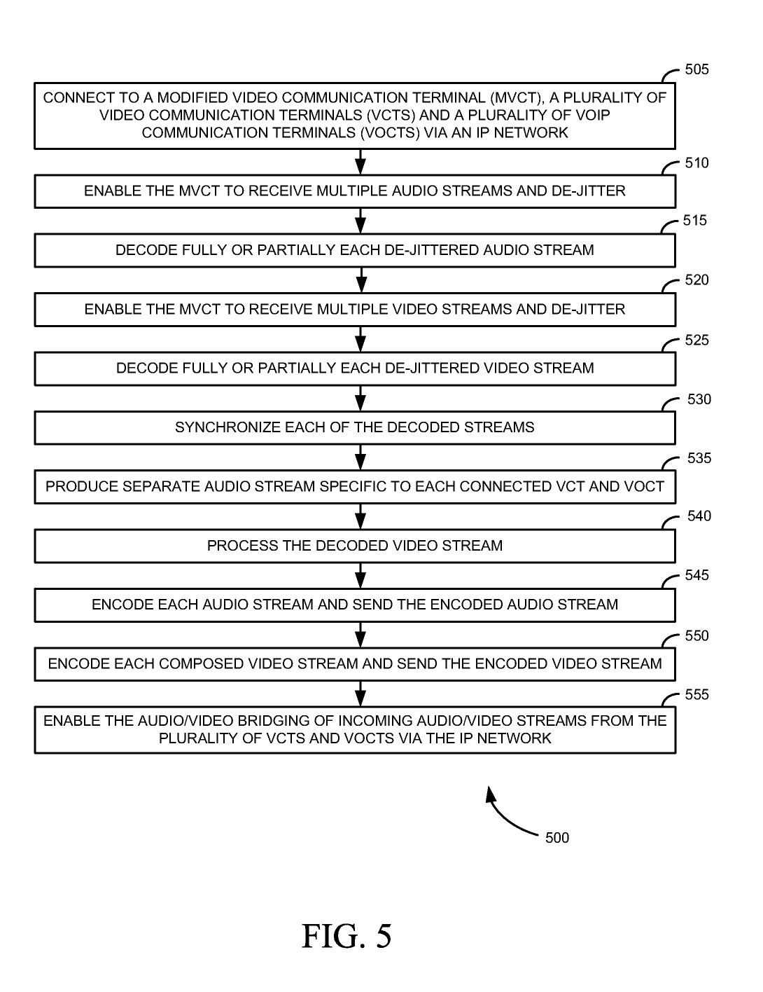

FIG. 5 is a process flow 500 illustrating providing of in-built audio/video bridge on endpoints capable of IP video communication, according to one embodiment. In block 505, the MVCT, the one or more of VCTs and the one or more of VoCTs are connected via the IP network. Further, the MVCT includes the AVBM. In block 510, the MVCT is enabled to receive multiple audio streams and if required, de-jitters each audio stream independently in the ARM included in the AVBM. In block 515, each de-jittered audio stream is decoded fully or partially in the ADM included in the AVBM. In block 520, the MVCT is enabled to receive multiple video streams and if required, de-jitters each video stream independently in the VRM included in the AVBM. In block 525, each de-jittered video stream is decoded fully or partially in the VDM included in the AVBM.

In block 530, each of the decoded streams of each participant connected to the MVCT is synchronized before local play out, in the AVSM included in the AVBM. Further, the AVSM synchronizes the audio/video streams before encoding and streaming out to each connected VCTs and/or VoCTs. In block 535, the audio stream coming from each connected VCTs or VoCTs is post processed before playback and/or re-encoded in the APMM included in the AVBM. Further, the APMM produces separate audio stream specific to each connected VCTs or VoCTs by removing an audio stream originating from that VCT or VoCT and mixing the audio streams coming from one or more other VCTs and/or VoCTs. In block 540, the decoded video stream received from the VDM, in block 525, is processed in the VPCM included in the AVBM. For example, processing the decoded video streams includes processes, such as resizing the video streams, and composing the video streams.

In block 545, each of the audio streams coming from the APMM, in block 535, is encoded in a format required by each of the associated and connected VCTs and VoCTs in the AEM included in the AVBM. Further, each of the encoded audio streams received from the AEM is sent to each of the associated VCTs and VoCTs. In block 550, each of the composed video streams coming from the VPCM, in block 540, is encoded in a format supported by each of the associated and connected VCTs in the VEM included in the AVBM. Further, each of the encoded video streams received from the VEM is sent to the respective VCTs. Furthermore, the AVBM using the AVTCM controls parameters such as, resolution, bit rate, frame rate and the like of the audio/video streams coming from each of the participants connected to the MVCT. This is explained in more detail with reference to FIG. 3. In block 555, the audio/video bridging of incoming audio/video streams from the one or more of VCTs and a one or more of VoCTs via the IP network is enabled by the AVBM for conferencing the participants.

In this embodiment, the audio/video bridging of the asymmetric audio/video streams from the one or more of VCTs and the one or more of VoCTs is enabled by the AVBM in the MVCT. Further, the number of endpoints that can participate is limited to the processing capability of the MVCT.

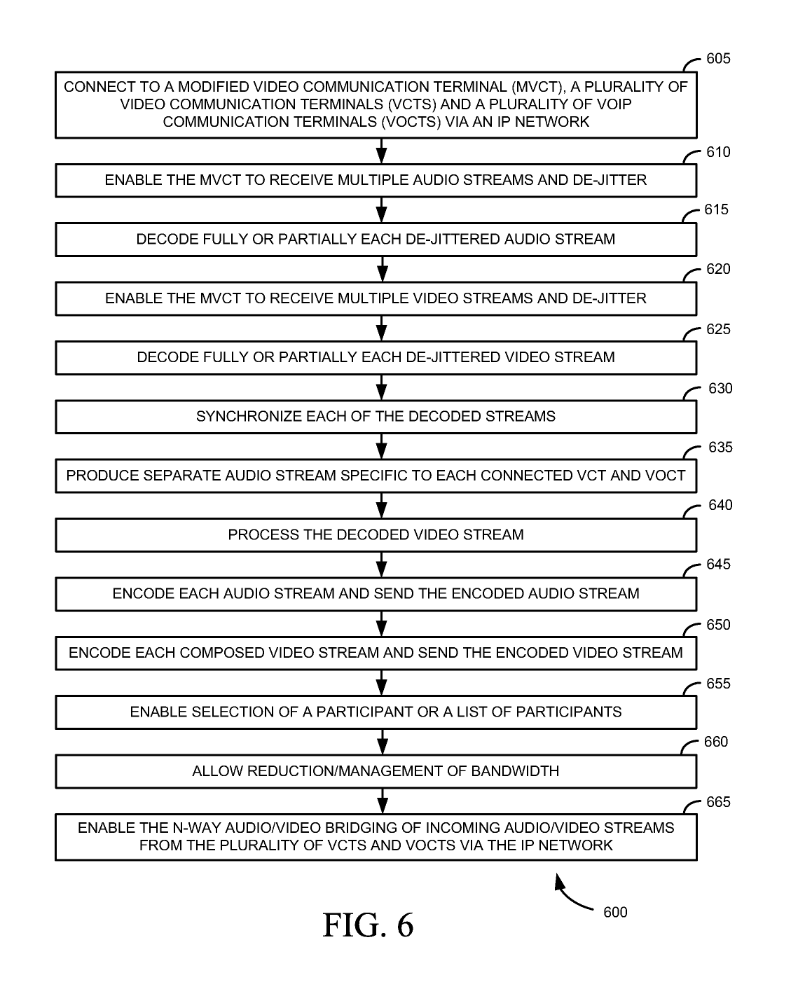

FIG. 6 is another process flow illustrating providing virtual n-way audio/video bridging of endpoints, according to one embodiment. In FIG. 6 blocks 600-650 is similar to the blocks 500-550 described with reference to FIG. 5 process flow.

In this embodiment, in block 655, the selection of the participant or the list of participants is enabled automatically based on preselected criteria or manually in the CSM included in the AVBM to enable virtual n-way audio/video bridging capability. In block 660, the reduction/management of bandwidth needed for conferencing the participants connected via the VCTs and/or the VoCTs is allowed in the EAVTCM included in the AVBM. This is explained in more detail with reference to FIGS. 3 and 4. In block 665, the virtual n-way audio/video bridging of incoming audio/video streams from the one or more of VCTs and a one or more of VoCTs via the IP network is enabled by the AVBM for conferencing the participants.

In this embodiment, the automatic/manual selection of the participants of the list of participants and the reduction/management of bandwidth enables n number of endpoints to participate in the virtual n-way audio video bridging irrespective of the processing capability of the MVCT.

In one embodiment, the MVCT is configured to send instructions to each of the connected one or more of VCTs to encode and stream a lower resolution video and/or lower bit rate video which are then composed to create and send higher resolution video stream to reduce processing power required by the audio/video bridge by avoiding decode of multiple higher resolution video streams from the one or more of VCTs and at the same time reduce required bandwidth. In addition to reducing the processing power and the bandwidth required by the in-built audio/video bridge, the MVCT can also alleviate the need for resizing the one or more incoming video streams to a smaller size video.

In various embodiments, the systems and methods described in FIGS. 1 through 6 eliminates the need for an external dedicated bridge to enable video conferencing. Further, the number of participating endpoints can be increased beyond the simultaneous audio/video processing capacity of the MVCT. Furthermore, the systems and methods described in FIGS. 1 through 6 also reduces bandwidth and processing required for the audio/video bridging in the video conferencing system.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method for providing an in-built audio/video bridge on endpoints that are capable of video communication over Internet protocol (IP), comprising:
connecting to a modified video communication terminal (MVCT), one or more of video communication terminals (VCTs) and one or more of voice over IP communication terminals (VoCTs) via an IP network, wherein the MVCT includes an audio/video bridging module (AVBM); and
enabling the audio/video bridging of incoming audio/video streams from the one or more of VCTs and VoCTs via the IP network by the AVBM for conferencing the participants.

2. The method of claim 1, wherein the AVBM includes an audio receive module (ARM) for enabling the MVCT to receive multiple audio streams and de-jitter each audio stream independently, and wherein the AVBM further includes an audio decode module (ADM) for decoding fully or partially each de-jittered audio stream.

3. The method of claim 2, wherein the AVBM further includes a video receive module (VRM) for enabling the MVCT to receive multiple video streams and de-jitter each video stream independently, and wherein the AVBM further includes a video decode module (VDM) for decoding fully or partially each de-jittered video stream.

4. The method of claim 3, wherein the AVBM further includes an audio/video synchronizing module (AVSM) for synchronizing each of the decoded streams of each participant connected to the MVCT before local play out, and wherein the AVSM furthers synchronizes the audio/video streams before encoding and streaming out to each connected VCT and/or VoCT.

5. The method of claim 4, wherein the AVBM further includes an audio processing and mixing module (APMM) for post processing the audio stream coming from each connected VCTs or VoCTs before playback and/or re-encoding, and wherein the APMM produces separate audio stream specific to each connected VCTs or VoCTs by removing an audio stream originating from that VCT or VoCT and mixing the audio streams coming from one or more other VCTs and/or VoCTs.

6. The method of claim 5, wherein the AVBM further includes a video processing and composing module (VPCM) for processing the decoded video streams received from the VDM and wherein the processing the decoded video streams include processes selected from the group consisting of resizing the video streams, and composing the video streams.

7. The method of claim 6, wherein the AVBM further includes an audio encode module (AEM) for encoding each of the audio streams coming from the APMM in a format required by each of the associated and connected VCTs and VoCTs, and wherein the AVBM further includes an audio send module (ASM) for receiving each of the audio streams from the AEM and sending the encoded audio streams to each of the associated VCTs and VoCTs.

8. The method of claim 7, wherein the AVBM further includes a video encode module (VEM) for encoding each of the composed video streams coming from the VPCM in a format supported by each of the associated and connected VCTs, and wherein the AVBM further includes a video send module (VSM) for receiving each of the encoded video streams from the VEM and sending them to respective VCTs.

9. The method of claim 8, wherein the AVBM further includes an audio/video transmission module (AVTCM) to control parameters of the audio/video streams coming from each of the participants connected to the MVCT, wherein the parameters are selected from the group consisting of resolution, bit rate and frame rate.

10. The method of claim 9, wherein the AVBM further includes a call select module (CSM) for enabling selection of participant or a list of participants automatically based on preselected criteria or manually to enable a virtual n-way audio/video bridging capability.

11. The method of claim 10, wherein the AVBM further includes an enhanced audio/video transmission control module (EAVTCM) for allowing reduction/management of bandwidth needed for conferencing the participants connected via the VCTs and/or the VoCTs.

12. A non-transitory computer-readable storage medium for providing an in-built audio/video bridge to endpoints that are capable of video communication over Internet protocol (IP) having instructions that when executed by a computing device, cause the computing device to perform a method comprising:
connecting to a modified video communication terminal (MVCT), one or more of video communication terminals (VCTs) and one or more of voice over IP communication terminals (VoCTs) via an IP network, wherein the MVCT includes an audio/video bridging module (AVBM); and
enabling the audio/video bridging of incoming audio/video streams from the one or more of VCTs and VoCTs via the IP network by the AVBM for conferencing the participants.

13. The non-transitory computer-readable storage medium of claim 12, wherein the AVBM further includes an audio/video transmission module (AVTCM) to control parameters of the audio/video streams coming from each of the participants connected to the MVCT, wherein the parameters are selected from the group consisting of resolution, bit rate and frame rate.

14. The non-transitory computer-readable storage medium of claim 13, wherein the AVBM further includes a call select module (CSM) for enabling selection of participant or a list of participants automatically based on preselected criteria or manually to enable a virtual n-way audio/video bridging capability.

15. The non-transitory computer-readable storage medium of claim 14, wherein the AVBM further includes an enhanced audio/video transmission control module (EAVTCM) for allowing reduction/management of bandwidth needed for conferencing the participants connected via the VCTs and/or the VoCTs.

16. An in-built audio/video bridging system, comprising:
one or more of video communication terminals (VCTs);
one or more Internet protocol (IP) networks; and
one or more modified video communication terminals (MVCTs) including an in-built bridge capable of encoding/decoding incoming audio/video streams, wherein the one or more of VCTs, and the one or more MVCTs are coupled via the one or more IP networks, and wherein the MVCT comprises:
an audio/video bridging module (AVBM) for enabling audio/video bridging of incoming audio/video streams to the MVCT.

17. The system of claim 16, further comprising:
devices selected from the group consisting of one or more dedicated bridges, one or more voice over Internet protocol communication terminals (VoCTs) and one or more IP network devices and wherein the devices are coupled via the one or more IP networks.

18. The system of claim 17, wherein the AVBM comprises:
an audio receive module (ARM) to enable the corresponding one of the one or more MVCTs to receive multiple audio streams and de-jitter each audio stream independently; and
an audio decode module (ADM) to decode fully or partially each de-jittered audio stream.

19. The system of claim 18, wherein the AVBM further comprises:
a video receive module (VRM) to enable the corresponding one of the one or more MVCTs to receive multiple video streams and de-jitter each video stream independently; and
a video decode module (VDM) to decode fully or partially each de-jittered video stream.

20. The system of claim 19, wherein the AVBM further comprises:
an audio/video synchronizing module (AVSM) to synchronize each of the decoded audio/video streams of each participant connected to the corresponding one of the one or more MVCTs before local play out, and wherein the AVSM further synchronizes the audio/video streams before encoding and streaming out to each of the connected one or more VCTs and/or one or more VoCTs.

21. The system of claim 20, wherein the AVBM further comprises:
an audio processing and mixing module (APMM) to post process the audio stream coming from each connected one or more VCTs or one or more VoCTs before playback and/or re-encoding, and wherein the APMM produces separate audio stream specific to each connected one or more VCTs or one or more VoCTs by removing an audio stream originating from that VCT or VoCT and mixing the audio streams coming from one or more other VCTs and/or VoCTs.

22. The system of claim 21, wherein the AVBM further comprises:
a video processing and composing module (VPCM) to process the decoded video streams received from the VDM and wherein the processing the decoded video streams include processes selected from the group consisting of resizing the video streams and composing the video streams.

23. The system of claim 22, wherein the AVBM further comprises:
an audio encode module (AEM) to encode each of the audio streams coming from the APMM in a format required by each of the associated and connected one or more VCTs and one or more VoCTs; and
an audio send module (ASM) to receive each of the encoded audio streams from the AEM and sending the received encoded audio streams to each of the associated one or more VCTs and one or more VoCTs.

24. The system of claim 23, wherein AVBM further comprises:
a video encode module (VEM) to encode each of the composed video streams coming from the VPCM in a format supported by each of the associated and connected one or more VCTs; and
a video send module (VSM) to receive each of the encoded video streams from the VEM and send each of the encoded video streams to associated and connected one or more VCTs.

25. The system of claim 24, wherein the AVBM further includes an audio/video transmission module (AVTCM) to control parameters of the audio/video streams coming from each of the participants connected to the corresponding one of the one or more MVCTs, wherein the parameters are selected from the group consisting of resolution, bit rate and frame rate.

26. The system of claim 25, wherein the AVBM further comprises:
a call select module (CSM) to enable selection of a participant or a list of participants automatically based on preselected criteria or manually to enable a virtual n-way audio/video bridging capability; and
an enhanced audio/video transmission control module (EAVTCM) to allow reduction/management of bandwidth needed for conferencing the participants connected via the one or more VCTs and/or the one or more VoCTs.

27. An MVCT, comprising:
an in-built bridge capable of encoding/decoding incoming audio/video streams coming from one or more VCTs, one or more VoCTs, that are coupled to the MVCT via an IP network, wherein the in-built bridge comprises:
an audio/video bridging module (AVBM) for enabling audio/video bridging of incoming audio/video streams to the MVCT.

28. The MVCT of claim 27, wherein the AVBM further includes an audio/video transmission module (AVTCM) to control parameters of the audio/video streams coming from each of the participants connected to the MVCT, wherein the parameters are selected from the group consisting of resolution, bit rate and frame rate.

29. The MVCT of claim 28, wherein the AVBM further comprises:
a call select module (CSM) to enable selection of a participant or a list of participants automatically based on preselected criteria or manually to enable a virtual n-way audio/video bridging capability; and
an enhanced audio/video transmission control module (EAVTCM) to allow reduction/management of bandwidth needed for conferencing the participants connected via the VCTs and/or the VoCTs.
